(19) United States
(12) Patent Application Publication
(10) Pub. No.: US 2024/0194961 A1
(43) Pub. Date: Jun. 13, 2024

(54) A METHOD FOR RECYCLING OF USED SCRAP LITHIUM BATTERY

(71) Applicant: BATX ENERGIES PVT LTD, Gurgaon (IN)

(72) Inventor: Vikrant Singh, Kannauj (IN)

(73) Assignee: BATX ENERGIES PVT LTD, Gurgaon, HR (IN)

(21) Appl. No.: 18/556,710

(22) PCT Filed: Mar. 9, 2022
(86) PCT No.: PCT/IN2022/050211

§ 371 Date: Oct. 23, 2023

(30) Foreign Application Priority Data
Apr. 23, 2021 (IN) 202111018790

(51) Int. Cl. H01M 10/54; C22B 1/00; C22B 3/00; C22B 3/06; C22B 3/22; C22B 47/00

(52) U.S. Cl. CPC H01M 10/54; C22B 1/005; C22B 3/06; C22B 3/22; C22B 23/0407; C22B 47/00

(57) ABSTRACT

A method of extracting a plurality of battery materials from lithium batteries. The one or more battery materials recovered are selected from magnetic steel, copper, plastic, Aluminium, and dry mixed electrode powder.

### BACKGROUND OF THE INVENTION

### Field of the Invention

Embodiments of the present invention relates to the field of battery recycling. More particularly, the present application relates to methods, and systems for recovering materials from batteries, in particular spent lithium-ion batteries.

### Description of the Related Art

In the current era there is no sustainable approach and methodology for comprehensive recovery of Anode and Cathode materials from spent lithium-ion battery. Recently, electric vehicles are gaining popularity. However, the number of spent lithium-ion batteries that once powered those vehicles are also increasing simultaneously. Predictions by Industry analysts state that China alone has generated around 500,000 metric tons of used lithium-ion batteries in 2020. It is further predicted by 2030 the worldwide number is going to reach 2 million metric tons per year.

Handling methods and systems of spent lithium-ion batteries in conventional ways may end up in landfills even though lithium-ion batteries can be recycled. These popular power packs contain valuable metals and other materials that can be recovered, processed, and reused.

However, Indian government and the National Mission on Transformative Mobility and Battery Storage are focused on developing a domestic battery manufacturing ecosystem. Creating a battery manufacturing capability is a critical step but the input materials are also critical. With no current domestic battery Anode and Cathode capacity, India would need to import 100% of its battery Anode and Cathode graphite. Heavy reliance on non-domestic supply chains would impact India's ability to reach it select reification goals and also reduce its ability to mitigate severe price fluctuations. A reliable domestic raw materials supply chain will not only promote advanced manufacturing employment but helps serve as a natural hedge for wild price swings and supply constraints.

Currently, a physical sorting method for example grinding flotation is used for the special structural characteristics of graphite. Moreover, pyrolysis and calcination methods are used to recover Graphite from spent LIBs. However, these processes are only limited to laboratory scale because of their process complexity and operational cost.

Conventionally, the spent graphite is firstly separated from spent batteries by physical manual methods, including dismantling, crushing, screening, and other mechanical processes (Yang et al., 2016a, 2016b). There is no focused activity for the removal of graphite from Mixed Cathode and Anode and Cathode Material as mentioned in patent application number CN 201310306520 and then, the separated graphite can be used as the raw material of preparing graphene or other functional materials.

In recent years, China has increasingly shutdown numerous graphite plants due to air and water pollution. The very fine graphite dust generated from plants leaves a residue in the air and water supply leads to significant contamination. Moreover, India also has started to increase pollution standards in the graphite industry and recently closed a large synthetic graphite production plant in Bangalore. Furthermore, due to its importance as a key ingredient in li-ion batteries, graphite demand is forecasted to increase exponentially. Should the current battery mega factories utilize 100% capacity, Benchmark Mineral Intelligence estimates graphite demand will increase by 3× through 2023 and over 5× through 2028. Additionally, such demand versus supply is expected to create a graphite shortfall as early as 2025. Therefore, it is critically important to research novel methods and systems to successfully recover graphite through used batteries. Technological challenges in design and prototype manufacture based on innovator's skill Li-ion battery Anode and Cathodes are comprised of coated spherical purified graphite (CSPG), synthetic graphite or a combination mostly of CSPG. CSPG is currently 70% of the market demand and is forecasted to continue its dominance in battery Anode and Cathodes. The typical refining process for battery graphite Anode and Cathodes is to convert high quality natural flake to spherical graphite.

China controls 100% of global market for converting natural flake to uncoated spherical graphite, but the traditional process uses very large quantities of hydrofluoric acid and other harsh acids. In addition to the use of harsh acids, the Chinese government has recently clamped down and even closed numerous plants due to reducing wastewater pollution. Currently, most of the companies following smelting process to recycle lithium batteries requires more energy and at the same time efficiency is low in utilizing this type of separation process. Huge cost and resources are detrimental to be utilized as a process in recycling lithium battery.

Need of the hour for the recycling industry to meet international and domestic advanced level of clean production enterprises globally must adopt automatic crushing system. Moreover, clean production enterprises at the domestic level must adopt mechanical crushing and separation of Cathode and Anode materials with higher separation rate.

Most of the batteries that do get recycled undergo a high-temperature melting-and-extraction, or smelting, process similar to ones used in the mining industry. Those operations, which are carried out in large commercial facilities for example, in Asia, Europe, and Canada are energy intensive. Moreover, the plants are also costly to build and operate and require sophisticated equipment to treat harmful emissions generated by the smelting process. And despite the high costs, these plants don't recover all valuable battery materials.

Some Li-ion batteries use cathodes made of lithium cobalt oxide (LCO). Other Li-ion batteries use lithium nickel manganese cobalt oxide (NMC), lithium nickel cobalt aluminium oxide, lithium iron phosphate, or other materials. Moreover, in practice the proportions of the components within one type of cathode—for example, NMC—can vary substantially among manufacturers. The upshot is that Li-ion batteries contain a wide diversity of ever-evolving materials, which makes recycling challenging with the deployment of current methodology.

In use, large battery packs that power electric vehicles may contain several thousand cells grouped in modules. The packs also include sensors, safety devices, and circuitry that controls battery operation, all of which add yet another layer of complexity and additional costs to dismantling and recycle the batteries.

Pyro metallurgical recycling (smelting) of LIBs recovers valuable transition metals but leaves both the lithium and the aluminium in the slag, which makes them difficult to recover. Moreover, all of the organics and the aluminium are oxidized to supply process heat and reduce the transition metals. Therefore, no valuable product can be recovered from lithium iron phosphate (LFP) cathodes. In addition, a large capital expenditure is necessary for an economical industrial-scale smelting plant. However, much of the cost is due to the gas treatment to prevent release of fluorine compounds and harmful organics.

In 2018, the Lithium-ion Battery recycling market was valued approximately USD 2.2 billion and it is anticipated to grow with a healthy growth rate of more than 22.1% over the forecast period from 2019 to 2026. Today, Lithium-ion batteries are used in vast quantities in electronic and household devices. These batteries have an expected lifespan of 3-5 years. Lithium batteries application is very broad, and widely used in UPS mobile backups, mobile, electric mobility, energy grid storage systems etc. However, Lithium-ion batteries contain toxic and flammable components. Further, growing numbers of electric vehicles presents a serious waste-management challenge for recyclers at end-of-life. Nevertheless, spent batteries may also present an opportunity as manufacturers require access to strategic elements and critical materials for key components in electric-vehicle manufacture: recycled lithium-ion batteries from electric vehicles, mobile phones, grid storage, power banks, and small power electronic devices etc.

Advanced lithium-ion battery recycling processes could offer an economic and environmental opportunity. For example, the estimated 11+ million tonnes of spent battery packs contain approximately US $65 billions of residual value in metals and other components. Further, recycling lithium-ion batteries could reduce greenhouse gas emissions globally by approximately 1.2 billion equivalent tonnes of CO2 between 2017 and 2040 by providing an offset against/reducing the amount of raw material derived from primary sources (i.e., mining, refining), and, potentially prevent metals (e.g., heavy metals) and materials from spent lithium-ion batteries being landfilled.

Accordingly, the present methods, and systems recover materials from batteries, in particular spent lithium-ion batteries.

Accordingly, there remains a need in the art to develop an invention to overcome the problems imposed by the conventional prior arts. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

Various embodiments of present invention disclose methods, apparatus, and systems recover materials from batteries, in particular spent lithium-ion batteries. Aspects of the present application address the above-referenced matters, and others. By Recycling Lithium battery one is able to recover cathode & anode raw materials which provides a valuable secondary source of materials like Cobalt (Co), Coated Spherical Purified Graphite (CSPG), Nickel (Ni), Manganese (Mn) and Lithium (Li). In general, cathodes consist of an electrochemically active powder (LCO, NMC, etc.) mixed with carbon black and glued to an aluminium-foil current collector with a polymeric compound such as poly (vinylidenefluoride) (PVDF). Anodes usually contain graphite, PVDF, and copper foil. Separators, which insulate the electrodes to prevent short circuiting, are thin, porous plastic films, often polyethylene or polypropylene. The electrolyte is typically a solution of LiPF6 dissolved in a mixture of ethylene carbonate and dimethyl carbonate. The components are tightly wound or stacked and packed securely in a plastic or aluminium case.

In one embodiment, the methods to recover one or more battery materials from spent lithium-ion batteries are disclosed. In operation, the present method is able to extract metals and non-metals from cathode and anode electrode materials of lithium batteries in dry and wet powder form using multiple steps. Particularly, the multiple steps include physical Electro-mechanical separation, Hydrometallurgical and chemical processes.

In yet another embodiment, the lithium Scrap batteries are collected into a housing for example a bin and then passed through pre-treatment process before shredding lithium Scrap batteries. In operation, the lithium Scrap batteries are passed through one or more refining processes to form a feedstock. Subsequently, the feedstock is conveyed to a conveyor module.

In yet another embodiment, the formed feed stock is cryogenically cooled and subsequently shredded to form shredded particles by a shredding module in a nitrogen contained closed environment.

In yet another embodiment, the shredding module includes a battery shredding level one module and a secondary shredding level two module with low-speed rotating shear blades followed by deployment of at least one electromechanical process or in combination of electromechanical processes selected from frictional crushing, magnetic separation, wet impact crushing, wet screening and the like.

In yet another embodiment, Copper, Aluminum, plastic and steel are recovered after the deployment of at least one electromechanical process or in combination of electromechanical processes. Further, the present method includes the steps of Electrode material Hydrometallurgical and direct recycling process to recover Graphite, cobalt, nickel, manganese, lithium and others after extraction from spent and scrap lithium batteries.

In one embodiment, the method for extracting a plurality of battery materials from lithium batteries includes the steps of sorting and screening of a plurality of battery cells based on different categories as per likelihood of cells, pretreatment of the plurality of battery cells into a plurality of formed batches, storing the plurality of formed batches of pretreated batteries in a battery storage bin, positioning the pre-treated batteries on a belt type chain conveyor unit, treating the pre-treated batteries in a battery liquid immersion chilling component module, wherein the pre-treated batteries are immersed in at least one heat capacity solution in a temperature range of about minus 5 degrees Celsius to minus 10 degrees Celsius for about one to three minutes to stop ionic mobility of said lithium-ion cells.

In another embodiment, the method further includes the steps of primary shredding of the treated lithium-ion cells is performed in a battery shredder. Particularly, the shredder is a liquid based shredding level one module. Further, secondary shredding of the shredded lithium-ion cells is performed in a secondary shredding level two module. Further, inert gas is provided to the shredded lithium-ion cells to reduce possibility of fire.

In yet another embodiment, the shredded battery pieces are further processed from the battery shredding level one module and the battery shredding level two module by a frictional impact crusher for separating electrode powder from the shredded material. The separated solidified material is dumped from black powder from the shredded pieces of cells into a magnetic steel separator to extract steel from the shredded pieces of cells. Thereafter, the leftover shredded pieces of cells are sorted by a dry vibrator mesh screen.

In one embodiment, the one or more battery materials recovered are selected from magnetic steel, copper, plastic, Aluminium, and dry mixed electrode powder.

In yet another embodiment, the method further includes the steps of removal of a plurality of inert gases by deploying at least one negative pressure cyclone, sucking out the plurality of inert gases from the treated lithium-ion cells and sending the plurality of inert gases into a gas treatment scrubber to separate all gases separately, and discharging separated gases into the atmosphere after passing through a series of filters. Particularly, mixing gases sucked into a negative pressure duct with CNG and burning mixed gases in a tube-based furnace to breakdown a plurality of harmful gases into decomposed harmful gases, and passing the decomposed harmful gases through a caustic scrubber using water and calcium hydroxide. Further, the decomposed harmful gases react with calcium hydroxide and form a plurality of inert solid compounds which can be disposed to the landfill. The plurality of harmful gases is toxic and flammable such as hydrogen, phosphine and hydrofluoric acid evolving from electrolyte solution.

In one embodiment, the plurality of inert gases is selected from nitrogen gas, hydrogen fluoride, and carbon dioxide.

In one embodiment, the shredded pieces of cells pass through an angular blade axial flow frictional impact crusher at an angle of 5-7 degree and the frictional impact crusher is able to crush black powder consisting earthen oxides and other elements along with a plurality of materials and the plurality of materials are selected from steel, plastic, aluminum foil and the like.

In one embodiment, the magnetic steel separator pulls back steel material and other similar materials prone to magnet elements from shredded pieces of cells and the black powder is separated from the solidified material. Further, the leftover shredded pieces of cells are sieved through dry vibrating screen having the amplitude of 50 mm wherein a primary screen is about 1 mm and a secondary screen is about 0.5 mm.

In one embodiment, the leftover shredded pieces of cells include black powder along with aluminum foil and copper foil are screened through the primary screen separating aluminum foil and copper foil and extracted Aluminum foil and copper foil are further transferred for a wet chemical treatment.

In one embodiment, the method further includes the step of treating aluminum and copper foil with acids, bases and other oxidizing chemicals along with deployment of an integrated wet impact centrifuge module to obtain minutiae black powder flakes left behind in aluminum and subsequently plastic and copper foil are separated.

In one embodiment, the method further includes the steps of influxing a wet electrode tank with wet electrode powder from wet chemical treatment along with dry electrode powder from the dry vibrating mesh having stir rotating at 300 rpm with angular perforated blades to obtain a first mixture, sending the first mixture from the wet electrode tank to a leaching reactor and leaching is performed by using appropriate oxidizing agents along reducing agents and necessary chemicals at 80 to 100 degree Celsius having concentration at a level around 0.5 to 2 molar with pH value approximate to 1 to 3.5, with variable agitating rpm system, and transferring leached liquid to the wet impact centrifuge module from the leaching reactor containing filter cloth to extract graphite and the centrifuge module rotates with 900-1500 rpm having filter cloth at its periphery to filter soluble metal leached liquor.

In one embodiment, the method further includes the steps of recovering anode electrode material by filtering leached liquid with 1-10 micron filter cloth and storing in leached liquor storage tank, adding base to the leached liquor to increase pH range from 1-2 to 3-5, solvent extraction to extract manganese salt, solvent extraction followed by standard precipitation to extract cobalt salt; and performing extraction of Nickel salt at some pH value and at higher temperature above the room temperature. In operation, the wet impact centrifuge module is able to extract Anode Electrode Material with high purity and Anode Electrode Material is graphite.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A, and FIG. 1B illustrates a flow diagram of a method for recovery of multiple battery materials from lithium scrap battery, in accordance with one or more embodiments of the present invention; and

FIG. 2 illustrates a block diagram for extracting battery materials by deploying the present method steps, in accordance with one embodiment of the present invention;

ELEMENT LIST

| | |
|---|---|
| Lithium Batteries 121 | Battery Storage Bin 102 |
| Bucket type chain conveyor module | Battery liquid Chilling System 103 |
| 101 | |
| Battery shredding level one module | Secondary shredding level two |
| 106 | module 107 |
| Frictional impact crusher 109 | Magnetic steel separator 111 |
| Dry vibrating screen separator 112 | Wet Chemical treatment Unit 114 |
| Wet Impact Centrifuge 116 | Leaching reactor 118 |
| GAS Treatment Scrubber 128 | Negative Pressure Cyclones 129 |

### DETAILED DESCRIPTION

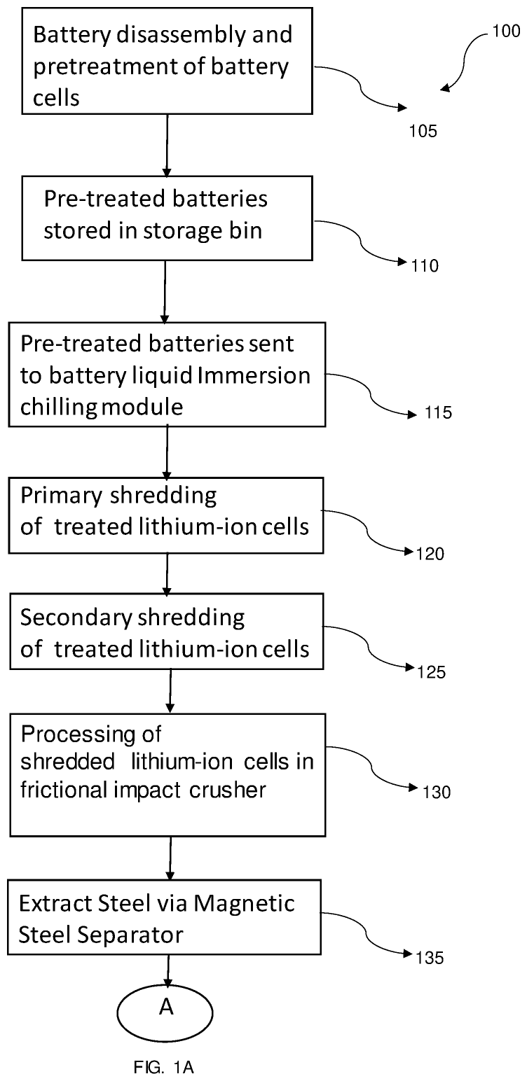

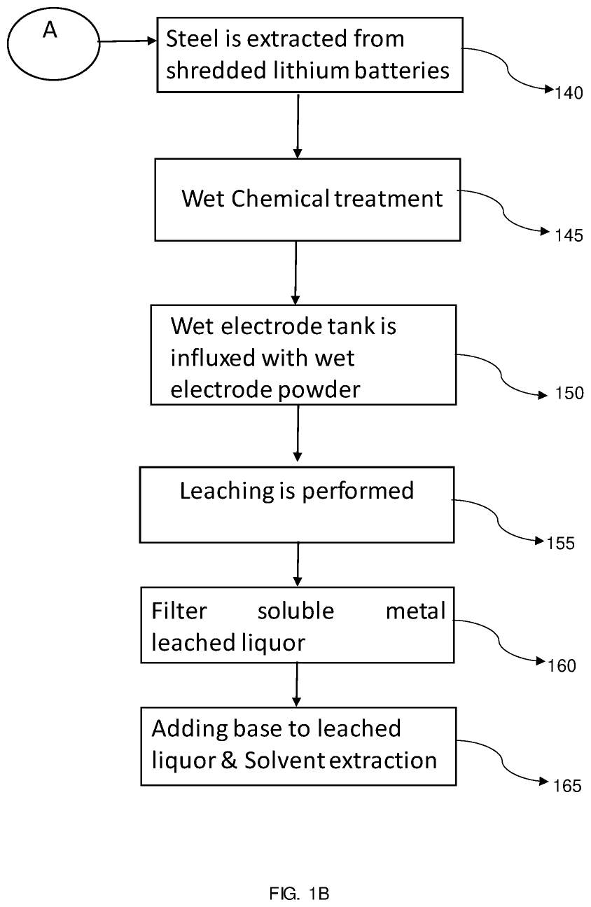

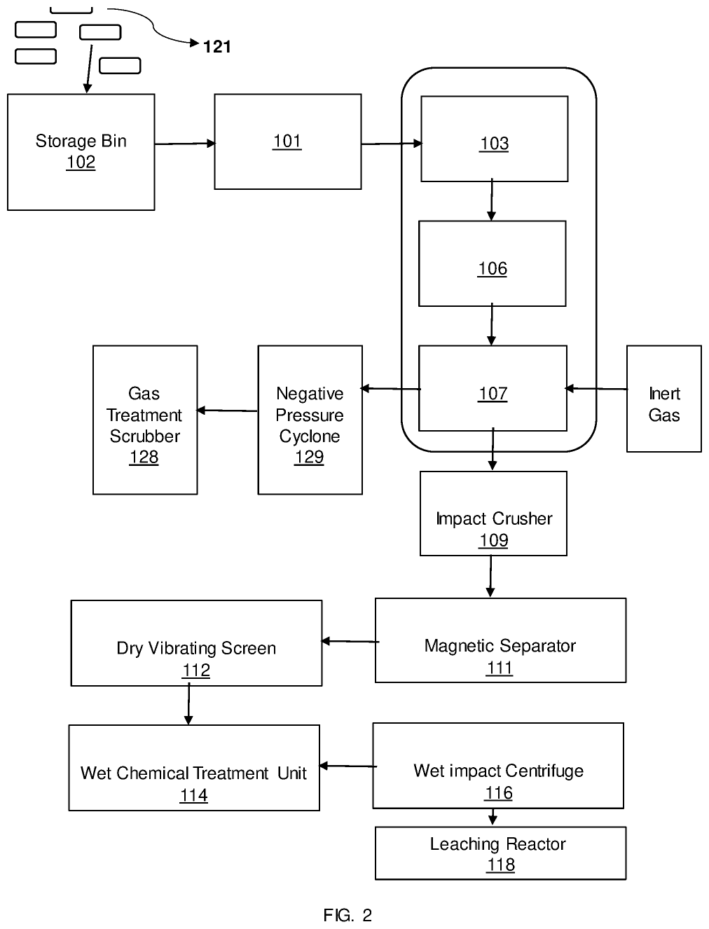

Embodiments of the present disclosure relates to methods, and systems for recovering materials from batteries, in particular spent lithium-ion batteries. Moreover, the principles of the present invention and their advantages are best understood by referring to FIG. 1A to FIG. 2. In the following detailed description of illustrative or exemplary embodiments of the disclosure, specific embodiments in which the disclosure may be practiced are described in sufficient detail to enable those skilled in the art to practice the disclosed embodiments. For example, specific details such as specific method steps, structures, elements, and connections are presented herein. However, it is to be understood that the specific details presented need not be utilized to practice the embodiments of the present disclosure.

The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

Unless defined otherwise, all technical and scientific terms used herein have the same meaning as commonly understood by one of ordinary skill in the art to which this application belongs. As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

The term “battery” or “batteries” are used herein refer to rechargeable lithium-ion batteries, unless the context clearly dictates otherwise.

FIG. 1A, and FIG. 1B illustrates a flow diagram of a method for recovery of multiple battery materials from lithium scrap battery, in accordance with one or more embodiments of the present invention. FIG. 2 illustrates a block diagram for extracting battery materials by deploying the present method steps, in accordance with one embodiment of the present invention. Particularly, copper, plastic, Aluminium, and dry mixed electrode powder are separated from Magnetic (steel) present in a lithium battery. The method 100 starts at step 105 and proceeds to step 110. At step 105, the batteries 121 are disassembled and pretreatment of Lithium-ion cells includes sorting and screening of cells into different categories as per likelihood of cells. Once the pre-treatment process is done method 100 proceeds to step 110. At step 110, the formed batch is sent towards battery storage bin 102 (FIG. 2).

In one embodiment of the present invention, once the batteries are stored in the battery storage bin 102 (FIG. 2), the pre-treated batteries 121 (FIG. 2) are put on a belt type chain conveyor module 101.

In one embodiment of the present invention, the conveyor module 101 is operated at a linear speed around 4.48 to 10 m per minute having the variable speed of approximately 10 feet long conveyor belt. Subsequently, the pre-treated batteries 121 from the battery storage bin 102 are sent to battery liquid Immersion chilling component module 103 (FIG. 2). In use, the pre-treated Lithium-ion batteries are immersed in the solution such as glycol or other heat capacity solutions at a temperature between −5 to −10 degree Celsius for 1 to 3 minutes which stops ionic mobility resulting in better shredding and reduces the possibility of fire to negligible. Further, at freezing temperatures of about −5 to −10 degree Celsius, the lithium-ion cells are soaked up in porous graphite. As a result, flow of lithium ions falls, hence reducing the capacity of the battery.

In one embodiment, the method 100 proceeds to step 120. In operation at step 120, once the lithium-ion cells are treated in battery liquid Immersion chilling component module 103, the treated lithium-ion cells are sent for primary shredding. The primary shredding of the treated lithium-ion cells is performed in a battery shredding level one module 106. In use the shredded battery pieces from the battery shredding level one module 106 are processed by a frictional impact crusher (not shown) for separating electrode powder from the shredded material.

In one embodiment, the method 100 proceeds to step 125 from step 120. In operation at step 125, secondary shredding of shredded lithium-ion cells is performed in a secondary shredding level two module 107. Once the lithium-ion cells are treated in battery liquid Immersion chilling component module 103, the treated lithium-ion cells are sent in Nitrogen enclosed environment to secondary shredding level two module 107. In operation, Nitrogen gas procured from the Nitrogen gas cylinder (not shown) reduces the possibility of fire to negligible.

In one embodiment, the lithium-ion cells are shredded into a length of approximately 10 to 15 mm, and primary shredding having the constant RPM of 20-35 rotation per minute in the battery shredding level one module 106. The shredded lithium-ion cells are sent to secondary shredding level two module 107. The shredded battery pieces having an approximate length between 10 to 15 mm are again shredded in the secondary shredding level two module 107 having the constant rpm of 25-50 rotation per minute. In operation, the length of shredded battery pieces reduces to approximately 4 to 5 mm.

In yet another embodiment, battery shredding is performed in a nitrogen enclosed environment for both battery shredding level one module 106 and the secondary shredding level two module 107. Once both processes are performed, Nitrogen gas along with other harmful gases such as Hydrogen Fluoride, carbon dioxide are sucked out through the negative pressure cyclones 129 (FIG. 2).

In one embodiment, the sucked inert gases are sent into a gas treatment scrubber 128 (FIG. 2). The gas treatment scrubber 128 has the ability to separate all gases separately, thereafter discharged into the atmosphere after passing through a series of filters and get treatment in a scrubbing module.

In one embodiment, the method 100 proceeds to step 130. In operation at step 130, the shredded battery pieces resulting from battery shredding level one module 106 and the secondary shredding level two module 107 are sent towards the frictional impact crusher 109. Once the shredded pieces are received into the frictional impact crusher 109, the shredded pieces of cells pass through the angular blade axial flow impact crusher 109 at an angle of 5-7 degree. Particularly, the frictional impact crusher 109 is able to crush the black powder consisting earthen oxides and other elements along the steel, plastic, aluminum foil etc.

In one embodiment, the method 100 proceeds to step 135. At step 135, the separated solidified material from black powder is dumped into magnetic steel separator 111 (FIG. 2) to extract steel from the shredded pieces of cells.

Further, in use the magnetic steel separator 111 pulls back the steel and other similar materials prone to magnet elements from the shredded pieces. As a result, the black powder is separated from the solidified material. Subsequently, the extracted steel is the final product of the recycling process which is further stored in the inventory for sale. In use, the magnetic steel separator 111 is sent outward through a different set of conveyor belts.

In one embodiment, the method 100 proceeds to step 140 as illustrated in FIG. 1B. At step 140, once the steel is extracted from the shredded lithium batteries, the leftover is sent towards the dry vibrating screen 112 having the amplitude of 50 mm along a primary screen of 1 mm and secondary screen of 0.5 mm.

In one embodiment, the black powder along with aluminum foil and copper foil is screened through the primary screen, separating aluminum and copper foil. Once the Aluminum and copper foil is separated along with plastic (separator), the black mass powder is passed through the secondary screen, being refined up to 100-200 microns. Further, the refined black powder passed through the secondary screen is stored in the powder storage tank.

In one embodiment, the method 100 proceeds to step 145. At step 145, the extracted Aluminum and copper foil are separated through the primary screen is further transferred to a wet chemical treatment module 114 for a chemical treatment to further divide leftover materials. In operation, the extracted aluminum and copper foil is received in the wet chemical treatment module 114. The aluminum and copper foil are treated in the wet chemical treatment module 114 with certain acids and bases and other oxidizing chemicals along with deployment of an integrated wet impact centrifuge module 116. As a result, minutiae black powder flakes are left behind in aluminum. Subsequently, the plastic and copper foil are separated.

In one embodiment, the method 100 proceeds to step 150 from step 145. At step 150, the wet electrode tank is influx with wet electrode powder from wet chemical treatment module 114 along with dry electrode powder from the dry vibrating mesh having stir rotation at 300 rpm with angular perforated blades. The method 100 proceeds to step 155 from step 150. At step 155, the formed mixture from the wet electrode tank is sent towards the leaching reactor 118. Further, once the mixture from the wet electrode tank is received inside the leaching reactor 118, the leaching is performed by using appropriate oxidizing agents along with reducing agents and necessary chemicals are utilized at 80 to 100 degree Celsius having concentration at a level around 1 to 2 molar with pH value approximate to 1 to 3.5, with variable agitating rpm system.

In one embodiment, the method 100 proceeds to step 160 from step 155. At step 160, the liquid is transferred to a centrifuge (not shown) from the leaching Reactor 118 containing filter cloth to extract high purity grade graphite (organic Matter, non-soluble). Particularly, the centrifuge rotates at 900-1500 rpm having filter cloth at the periphery to filter soluble metal leached liquor.

In yet one embodiment, the centrifuge is able to extract graphite (Anode Electrode Material) with high purity. The anode material recovery remaining leached liquor is filtered with 1-10-micron filter cloth and stored in leached liquor storage tank (not shown). In yet one embodiment, the wet impact centrifuge module is the centrifuge. The wet impact centrifuge module is able to extract anode electrode material with high purity and anode electrode material is graphite.

The method 100 proceeds to step 165 from step 160. At step 165, the present method proceeds to the step of adding base to the leached liquor to make pH from 1-2 to 3-5 pH. Once the pH of the leached liquor reaches in the range of 3-5 pH then extraction step is performed. In use, the extraction of manganese salt is performed using solvent extraction method. Particularly, hydrometallurgical process is performed. The extraction of cobalt salt is recovered using solvent extraction followed by standard precipitation. Finally, extraction of Nickel salt is performed in the pH range from 2 to 8 and at higher temperature above the room temperature. The step of precipitation is performed and then filtered and dried in hydroxide or Sulphate form.

The advantage of the present invention is going to benefit the society at large. The present systems and methods are emerging technologies for recycling Lithium batteries. There are several major benefits as a result of recovering graphite materials from end-of life li-ion batteries. The recovery of valuable graphite is usable for new materials and subsequently, reduce the amount of future mining. Over years, traditional graphite mining and subsequent downstream refining process significantly impacts the environment. Recovering valuable graphite from batteries provides a huge opportunity to develop novel, environmentally-safe raw material production methods, as well as extends the lifecycle of raw materials. The present Lithium battery recycling method is able to target a wider spectrum of compounds, thus reducing the environmental impact associated with lithium battery production.

Moreover, the present methods deploy a combination of mechanical processing, and hydro- and pyro metallurgical steps to obtain materials suitable for LIB re-manufacture. The present process reduces numerous steps in the traditional supply chain for natural flake (predominant type) to be converted to spherical graphite and then eventually become part of the Anode and Cathode. Furthermore, recycling eliminates the supply chain requirements prior to purification since recycling recovers spheronized graphite. This reduction in the mining requirement and supply chain complexity would lower the overall carbon footprint of the process.

The present invention would be able to establish India as a technology leader in battery grade Anode and Cathode production from used cells. Moreover, the present recycling system and methods presents an excellent opportunity to start building a domestic capability and employment base for Anode and Cathode production. Based on the market growth, the graphite Anode and Cathode ecosystem could generate thousands of high-quality engineering and manufacturing jobs. Further, deployment of the present method would facilitate development of a domestic graphite supply capability for India to supply cell manufacturers.

The present recycling method enables domestic supply that, at a minimum, could help hedge supply chain risks. Moreover, a large recycling capacity also creates the opportunity for export should excess reserves be created above the domestic requirement. The Indian government and the National Mission on transformative mobility and battery storage are focused on developing a domestic battery manufacturing ecosystem. Furthermore, the present invention provides a reliable domestic raw materials supply chain not only promotes advanced manufacturing employment but helps serve as a natural hedge for wild price swings and supply constraints.

A key advantage of recovering graphite from used li-ion batteries is that the recovered graphite is already coated and spherical. The present invention addresses key technical challenges and present an environmentally-friendly, non-polluting process that enables the following through one integrated system of separating the Anode and Cathode electrode after shredding the complete cell and separating it from the cathode material by leaching.

1-17. (canceled)

18. A method of extracting a plurality of battery materials from lithium batteries, the method comprising:
positioning pre-treated batteries on a belt-type chain conveyor;
inhibiting ionic mobility of the pre-treated batteries in a battery liquid immersion chilling component by immersing the pre-treated batteries in a heat capacity solution within a temperature range ranging from −5 degrees Celsius to −10 degrees Celsius for a duration of one to three minutes;
performing primary shredding of the pre-treated batteries in a battery shredder using a battery shredding first level to form primary shredded battery materials,
wherein the primary shredded battery materials are shredded into a length ranging from 10 to 15 millimetres; and
wherein the battery shredding first level is operated at an rpm ranging from 20 to 35 rotations per minute;
performing secondary shredding of the primary shredded battery materials using a secondary shredding second level to form secondary shredded battery materials,
wherein the secondary shredding is performed in the presence of a inert gas to reduce a possibility of fire;
wherein the secondary shredded battery materials are shredded into a length ranging from 4 to 5 millimetres; and
wherein the secondary shredding second level is operated at an rpm ranging from 25 to 50 rotations per minute;
processing the secondary shredded battery materials by a frictional impact crusher to segregate electrode powder from the secondary shredded battery materials to form separated solidified material;
disposing of the separated solidified material into a magnetic steel separator to extract steel, wherein the steel is extracted from the separated solidified material to form a leftover solidified material; and
sorting the leftover solidified material by a dry vibrator mesh screen to recover the plurality of battery materials, wherein the plurality of battery materials comprises at least one of magnetic steel, copper, plastic, Aluminium, and dry mixed electrode powder.

19. The method according to claim 18, wherein the pre-treated batteries are obtained by steps comprising:
sorting and screening of the lithium batteries;
pretreatment of the lithium batteries; and
storing a plurality of formed batches of the pre-treated lithium batteries in a battery storage bin.

20. The method according to claim 18, wherein the method further comprises:
removing a plurality of inert gases by deploying at least one negative pressure cyclone;
sucking out the plurality of inert gases from the pre-treated lithium batteries;
sending a sucked plurality of inert gases into a gas treatment scrubber to separate all gases separately; and
discharging separated gases into atmosphere after passing through a series of filters;
wherein the plurality of inert gases comprises at least one of a nitrogen gas, hydrogen fluoride, and carbon dioxide; and
wherein an aggregator is configured to remove harmful gases in operation of the fractional impact crusher and a wet screener and the harmful gases aggregated by the aggregator are filtered by at least one filter for processing.

21. The method as claimed in claim 20, wherein the method further comprises:
mixing the sucked plurality of inert gases into a negative pressure duct with CNG and burning mixed gases in a tube-based furnace to breakdown a plurality of harmful gases into decomposed harmful gases; and
passing the decomposed harmful gases through a caustic scrubber using water and calcium hydroxide, and the decomposed harmful gases is reacted with calcium hydroxide to form a plurality of inert solid compounds;
wherein said plurality of harmful gases are toxic and flammable comprising hydrogen, phosphine and hydrofluoric acid evolving from electrolyte solution.

22. The method according to claim 18, wherein the frictional impact crusher comprises an angular blade axial flow frictional impact crusher at an angle of 5-7 degree and the frictional impact crusher is able to crush the segregated electrode powder consisting earthen oxides and other elements along with the plurality of battery materials.

23. The method according to claim 18, wherein the method further comprises:
treating aluminium and copper foil with acids, bases and other oxidizing chemicals along with deployment of an integrated wet impact centrifuge and air flow separator to obtain minutiae black powder flakes left behind in aluminium and subsequently plastic and copper foil are separated.

24. The method according to claim 18, wherein the method further comprises:
influxing a wet electrode tank with wet electrode powder from a wet chemical treatment component along with dry electrode powder from the dry vibrating mesh screen having stir rotating at 300 rpm with angular perforated blades to obtain a first mixture;
sending the first mixture from the wet electrode tank to a leaching reactor, wherein leaching is performed in the leaching reactor by using oxidizing and reagents along with reducing agents and necessary chemicals at 80 to 100 degree Celsius having concentration at a level ranging from 0.5 to 2 molar with pH value ranging from 1 to 3.5, with variable agitating rpm system; and
transferring leached liquid to the wet impact centrifuge from the leaching reactor containing filter cloth to extract graphite and the wet impact centrifuge and long press filtration system rotates with 900-1500 rpm having filter cloth at its periphery to filter soluble metal leached liquor.

25. The method according to claim 24, wherein the method further comprises:
recovering anode electrode material by filtering leached liquid with a filter cloth and storing in leached liquor storage tank;
adding base to the leached liquor to increase pH range from a range of 1-2 to a range of 3-5;
performing solvent extraction to extract manganese salt;
performing standard precipitation to extract cobalt salt; and
performing extraction of Nickel salt at higher temperature above the room temperature;
wherein, the wet impact centrifuge is able to extract the anode electrode material with high purity and the anode electrode material is graphite.

26. The method according to claim 18, wherein the magnetic steel separator pulls back steel material and other similar materials prone to magnet elements from the secondary shredded battery materials.

27. The method according to claim 18, wherein the conveyor is operated at a linear speed in a range of 4.48 to 10 m per minute.

28. The method according to claim 18, wherein the at least one heat capacity solution is Glycol.

29. The method according to claim 18, wherein the inert gas is Nitrogen and the Nitrogen is procured from a Nitrogen gas cylinder.

30. The method according to claim 18, wherein the magnetic steel separator is positioned outward through another set of conveyor belts.

31. The method according to claim 18, wherein the leftover solidified material is sieved through the dry vibrating screen having an amplitude of 50 mm, wherein the dry vibrating screen comprises a primary screen and a secondary screen, and wherein a primary screen is about 1 mm and a secondary screen is about 0.5 mm.

32. The method according to claim 31, wherein the leftover solidified material comprises black powder (Black mass) along with aluminium foil and copper foil and the black powder is screened through the primary screen separating aluminium foil and copper foil and the separated aluminium foil and copper foil are further transferred for a wet chemical treatment component.

33. The method according to claim 31, wherein the black powder is passed through the secondary screen, wherein the black mass is refined up to 100-200 microns.
